(19) United States
(12) Patent Application Publication
(10) Pub. No.: US 2007/0076087 A1
(43) Pub. Date: Apr. 5, 2007

(54) Optical disc apparatus

(76) Inventors: Hiroshi Nakane, Fukaya-shi (JP); Hideki Otsuka, Mishima-shi (JP); Mineharu Uchiyama, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/526,117

(22) Filed: Sep. 25, 2006

(30) Foreign Application Priority Data
Sep. 30, 2005 (JP) 2005-288803

(51) Int. Cl. B41J 2/435

(52) U.S. Cl. 347/224

(57) ABSTRACT

An optical disc apparatus comprises an pickup head, a printing device which prints information on a label surface based on a laser light emitted from the pickup head, and a focus control unit which adjusts a focus of the laser light based on the laser light reflected from the optical disc, wherein a size of the laser light used for adjusting the focus is larger than a size of the laser light used for printing the information.

### CROSS-REFERENCE TO RELATED APPLICATIONS

This application is based upon and claims the benefit of priority from prior Japanese Patent Application No. 2005-288803, filed Sep. 30, 2005, the entire contents of which are incorporated herein by reference.

### BACKGROUND OF THE INVENTION

1. Field of the Invention

The present invention relates to an optical disc apparatus which records information on an information recording layer of an optical disc and prints an image, a text or the like on a heat-sensitive label surface of the optical disc.

2. Description of the Related Art

A technique has been disclosed in which an image or a text such as a representative image or a title of a content is printed on the heat-sensitive label surface of the optical disc such as a DVD storing the content by using a pickup head for an information recording/reproducing apparatus (Jpn. Pat. Appln. KOKAI Publication No. 2003-203348). The label surface is a reverse surface of the information recording layer.

Since the surface roughness of the label surface is worse than that of the information recording layer, a noise of a focus error signal increases. Further, since the same pickup head is commonly used for recording the information and printing the title or the representative image, an optimum focal point of the pickup head for the label surface is greatly deviated from that for the information recording layer. Thus, a suitable focus servo control cannot be performed.

A focus servo system for properly positioning the focal point at a surface of the optical disc includes two kinds of servo system; one is a closed loop system which controls the focal point in real time. The closed loop system is generally called a focus servo system. The other is an open loop system which does not control the focal point in real time. In this system, the focus error signal is monitored to perform a focus control at certain time intervals. The open loop system is called a feed forward system.

In the information recording apparatus, an optical disc is rotated while performing a relative movement of a laser beam (the pickup head) and the optical disc. If the laser beam is focused on the disc by using an optical system to form a beam spot through a substrate of the disc, the beam spot size is increased and symmetry of a focus error signal is lost due to aberration. Further, because the label surface is formed by a silk printing or the like, the label surface has the surface accuracy degraded and a signal component corresponding to the surface roughness appears severely in the focus error signal. These factors give rise to difficulty of achieving stable focus servo for the label surface.

The focus depth of a surface of an optical disc is approximately 10 to 30 μm, a surface deflection of the optical disc may be approximately 0.5 mm or more for general compact discs. Thus, the optical disc cannot be practically used without the focus servo. Furthermore, because a focus error signal has a shape of an S-curve and the end of the S-curve contains important information for focus servo. If the surface roughness of the label surface is worse, the S-shape of the focus error signal is degraded and the real-time focus servo is not stabilized. Even in the feed-forward system, since a shape of a reflection signal is rough, it has a problem that the maximum value of the reflection signal cannot be stably detected.

### BRIEF SUMMARY OF THE INVENTION

It is an object of the present invention to provide an optical disc apparatus which reduces a noise in a detected signal used for a focus servo control and stabilizes the focus servo control.

According to an embodiment of the present invention, an optical disc apparatus using an optical disc having an information recording layer and a label surface, the apparatus comprising:

a pickup head which emits a laser light onto the optical disc;

a printing section which prints information on the label surface based on the laser light emitted from the pickup head; and

a focus control section which adjusts a focus of the laser light emitted from the pickup head to the label surface, wherein a size of the laser light used for adjusting the focus is larger than a size of the laser light used for printing the information on the label surface.

According to another embodiment of the present invention, an optical disc apparatus using an optical disk having an information recording layer and a label surface, the apparatus comprising:

a pickup head which emits a laser light onto the optical disc, the laser light including a main beam and two sub beams;

a tracking control section which shifts the pickup head to perform tracking based on a main beam and two sub beams reflected from the optical disc;

a focus control section which adjusts a focus of the light beam emitted from the pickup head based on a main beam and two sub beams reflected from the optical disc; and

a printing section which prints information on the label surface based on the main beam emitted from the pickup head.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a schematic view showing a notebook type personal computer including an optical disc apparatus according to an embodiment of the invention;

FIG. 2 is a schematic view showing an optical disc apparatus according to the embodiment of the invention;

FIG. 3 is a schematic view showing a state in which a drawer section is extracted from the optical disc apparatus of FIG. 2;

FIG. 4 is a block diagram showing a circuit construction of the optical disc apparatus according to the embodiment of the invention;

FIG. 5 is a schematic diagram that shows an optical system of a pickup head unit according to the embodiment;

FIG. 6 schematically shows the layout of three laser spots on the optical disc tracks including a main beam and two sub-beams in a differential push-pull (DPP) tracking control system;

FIG. 7 is a block diagram of a circuit that generates a reflection signal and a focus error signal;

FIG. 8 is a block diagram of a circuit that generates a tracking error signal;

FIG. 9 is a schematic diagram that indicates a measurement result of the focus error signal and the reflection signal for a label surface of the optical disc;

FIG. 10 is a schematic diagram that indicates a measurement result of the focus error signal and the reflection signal for an information recording layer (mirror surface) of the optical disc; and

FIG. 11 is a schematic diagram that shows an optical system of a pickup head unit according to the second embodiment.

### DETAILED DESCRIPTION OF THE INVENTION

Embodiments of an optical disc apparatus and a focus control method according to the present invention will now be described with reference to the accompanying drawings.

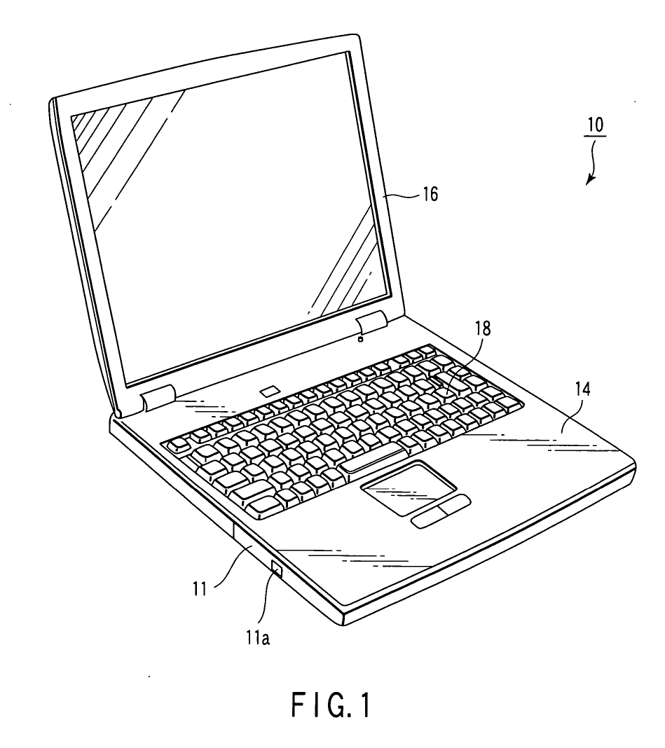

FIG. 1 shows a notebook type personal computer 10. The computer 10 includes a main body 14 and a display unit 16. The display unit 16 includes a display device such as a liquid crystal display (LCD) incorporated therein, and the LCD includes a display screen which is positioned substantially at a center of the display unit 16. The display unit 16 is attached to the main body 14 swingably between the open state and the closed state. FIG. 1 shows a front perspective view of an example of the personal computer 10 with the display unit 16 opened.

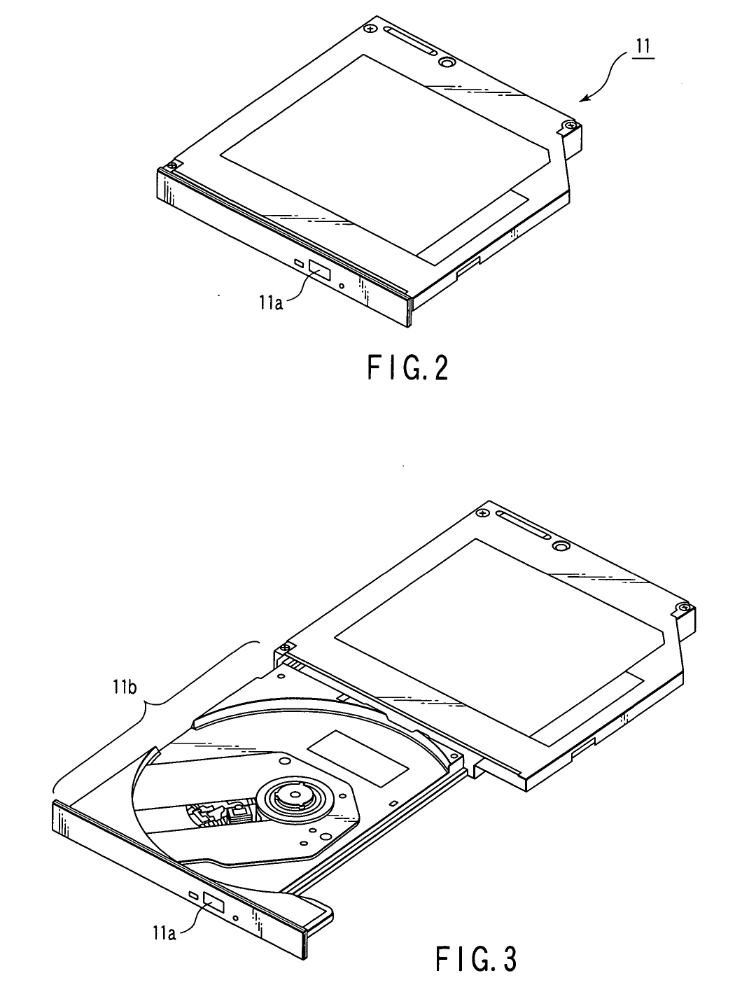

The main body 14 includes a substantial box-like case on which a keyboard 18 is disposed. Further, on a left side of the main body 14 is mounted a slim type optical disc apparatus 11 having a built-in DVD drive and the like. The optical disc apparatus 11 is shown in FIG. 2. The optical disc apparatus 11 includes an eject button 11a. Pressing the eject button 11a causes a drawer section 11b to be extracted, as shown in FIG. 3.

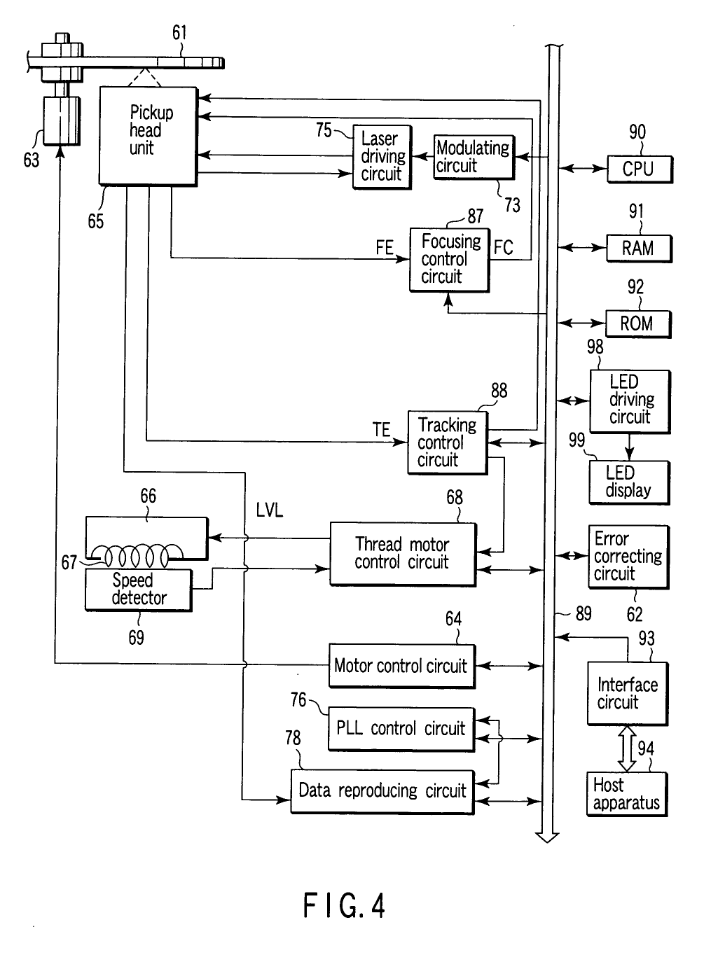

The computer 10 includes a semiconductor memory or a hard disc device for storing information to be recorded on the optical disc and information reproduced from the optical disc, and a CPU for instructing information-recording and information-reproduction to and from the optical disc apparatus 11, and processing this information. Its circuit diagram is shown in FIGS. 4A and 4B.

FIG. 4 is a block diagram showing an electronic circuit diagram of the optical disc apparatus according to the embodiment of the invention. An optical disc 61 which is loaded in the optical disc apparatus 11 can be of a user data recordable type optical disc or a read-only type optical disc having a heat-sensitive label surface. In this embodiment, a description will be given of the recordable type optical disc.

Information is recorded on or reproduced from the optical disc 61 by a pickup head unit 65. The pickup head unit 65 is connected to a thread motor 66 through a gear. The thread motor 66 is controlled by a thread motor control circuit 68.

A speed detector 69 is located below the thread motor 66, for detecting a moving speed of the pickup head unit 65, and then is connected to the thread motor control circuit 68. A speed signal of the pickup head unit 65 which is detected by the speed detector 69 is supplied to the thread motor control circuit 68. A permanent magnet (not shown) is disposed on a fixing section of the thread motor 66. When the thread motor control circuit 68 excites a driving coil 67, the pickup head unit 65 is driven in a radial direction of the optical disc 61.

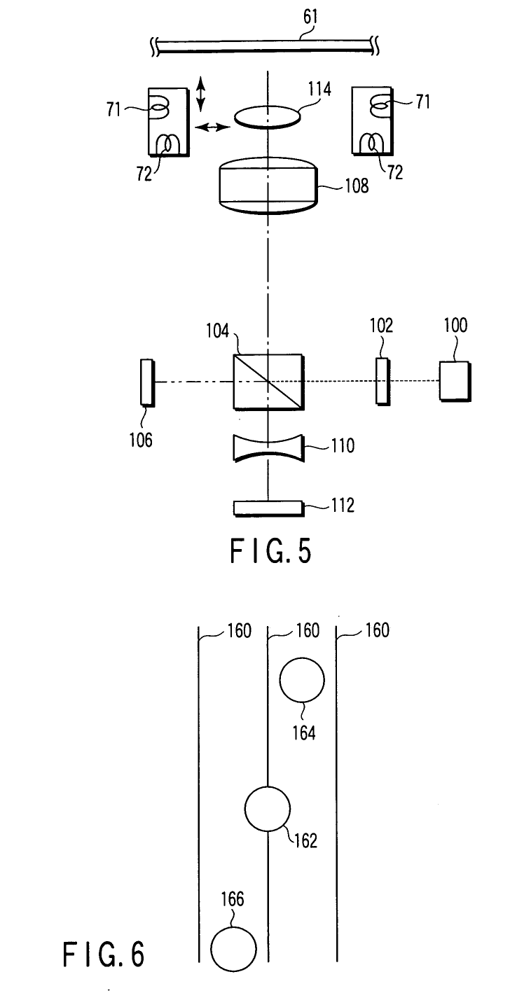

FIG. 5 shows an optical system of the pickup head unit 65. An objective lens 114 is supported by a wire or a plate spring (not shown), for example. The objective lens 114 is movable in a focusing direction (a lens optical axis direction) and a tracking direction (a direction perpendicular to the lens optical axis direction) by driving coils 71 and 72. A movement in the focusing direction (the optical axis direction) provides layer-jump.

A modulating circuit 73 receives a recording information signal from a host apparatus 94 through an interface circuit 93 and a bus 89 when recording information to the optical disc 61, and then modulates the recording information signal by a predetermined modulation manner (for example, 8-16 modulation) defined by a standard of the optical disc 61. A laser driving circuit 75 supplies a write pulse to a semiconductor laser diode 100 based on a modulated data supplied from the modulating circuit 73, when recording information to the optical disc 61 (when forming a mark). The laser driving circuit 75 supplies a reading signal, which is smaller than the write pulse, to the semiconductor laser diode 100 when reproducing the information.

The semiconductor laser diode 100 generates a laser beam in response to a signal supplied from the laser driving circuit 75. The laser beam emitted from the laser diode 100 is irradiated on the optical disc 61 through a grating 102, a half prism 104, a collimator lens 108, and the objective lens 114. The laser beam emitted from the laser diode 100 is also led to a front monitor 106 through the grating 102 and the half prism 104. The reflected light from the optical disc 61 is led to a photo detector 112 through the objective lens 114, the collimator lens 108, the half prism 104, and a cylindrical lens 110.

As described later, the pickup head unit 65 supplies a focus error signal FE to a focusing control circuit 87, a tracking error signal TE to a tracking control circuit 88 and a thread motor control circuit 68, and a reflection signal LVL to a data reproducing circuit 78.

The data reproducing circuit 78 reproduces the recorded data based on a reproducing clock signal from a PLL control circuit 76. The data reproducing circuit 78 includes a measuring function for measuring an amplitude of the reflection signal LVL. The measured value is output to a CPU 90 through the bus 89.

The thread motor control circuit 68 controls the thread motor 66, and hence moves the pickup head unit 65 in such a manner that the objective lens 114 is positioned in the vicinity of a center of the pickup head unit. 65.

The motor control circuit 64, the thread motor control circuit 68, the modulating circuit 73, the laser driving circuit 75, the PLL control circuit 76, the data reproducing circuit 78, the focusing control circuit 87, the tracking control circuit 88, or the like can be formed in one LSI chip, and then be controlled by the CPU 90 through the bus 89. The CPU 90 comprehensively controls the optical disc apparatus according to an operational command supplied from the host apparatus 94 through the interface circuit 93. The CPU 90 uses a RAM 91 as a work area, and then carrying out a predetermined control according to a program stored in a ROM 92, including a process according to the embodiment of the present invention.

Referring now to FIGS. 5 to 10, a focus control method for an optical disc device according to the embodiment of the present invention will be described.

According to the present embodiment, a DPP (differential push-pull) system using 3 beams is used for tracking control.

The operation for recording information to the information recording layer of the optical disc will be described. The optical disc 61 is set in such a manner that the information recording layer faces the pickup head unit 65.

A laser beam emitted from the laser diode 100 passes the grating 102 which divides the laser beam into three beams (see FIG. 6: one main beam 162 located on a target track 160 and two sub-beams 164, 166 located between the target track 160 and adjacent tracks 160). A light beam including three laser beams is divided into two by the half prism 104 which is translucent. The half prism 104 transmits one light beam (transmittance beam) to the front monitor 106 and transmits the other light beam (reflectance beam) to the collimator lens 108.

An output of the front monitor 106 is sampled and held at the timing of reproduction/recording/erase, etc. in an APC circuit in the laser driving circuit 75 and compared at respective reference levels to produce an error signal. The laser diode 100 is driven by the laser driving circuit 75 in accordance with the error signal at a desired timing.

On the other hand, the laser beams which are made into parallel beams by the collimator lens 108 are focused by the objective lens 114. The focused beam spots are irradiated to the information recording surface of the optical disc 61.

The light reflected at the optical disc 61 passes the objective lens 114, collimator lens 108, and half prism 104, and then, passes the cylindrical lens 110 for astigmatic correction, and the photo detector 112 is irradiated with the light.

Output of the photo detector 112 is sampled and held at a given timing to reproduce information or erase recorded information. The output of the photo detector 112 is processed by an RF amplifier (not shown) to obtain various signals such as a focus error signal FE, tracking error signal TE, reflection signal LVL, and wobble signal.

The focus error signal FE is characteristics-compensated by the focusing control circuit 87 and drives the drive coil 72 to move the objective lens 114 in the direction perpendicular to the optical disc 61. The tracking error signal TE is characteristics-compensated by the tracking control circuit 88 and drives the drive coil 71 to move the objective lens 114 in the radial direction of the optical disc 61. The wobble signal is generated from an absolute time in pre-groove (ATIP) signal, the absolute time in pre-groove (ATIP) signal is separated from the output of the reflection signal LVL by an RF amplifier (not shown).

In constant angular velocity (CAV) control, rotations of the spindle motor 63 are compared with the reference frequency so that a FG signal (rotation signal) achieves a desired frequency, and the spindle motor 63 is driven by an error signal between the FG signal and the reference frequency. In constant linear velocity (CLV) control, the wobble signal frequency is compared with the reference frequency (frequency and phase are compared), and the spindle motor 63 is driven by an error signal between the wobble signal frequency and the reference frequency.

Record information to be recorded on the optical disc 61 is received via the interface circuit 93 and the bus 89 from the host apparatus 94 as shown in FIG. 4 and is encoded in a desired format with predetermined additional information added by the CPU 90. In the timing that corresponds to the wobble signal, the laser diode 100 is driven by the laser driving circuit 75. Meanwhile, description on operations such as seek operation, focus-search, etc. is not given herein.

Description will be made with reference to an information printing on the optical disc label surface. The optical disc 61 is set in such a manner that the label printing surface faces the pickup head unit 65. As described above, the spindle motor 63 is driven by the error signal between the FG signal frequency and the reference frequency. The reference frequency is changed by the CPU 90 in accordance with the radial position of the optical disc 61 of the pickup head unit 65 to achieve CAV operation.

The radial position of the optical disc 61 (target position of the optical disc 61) is transmitted from the host apparatus 94 to the CPU 90 via the interface circuit 93 and the bus 89.

In the focus control by the focusing control circuit 87, angle information on one rotation of the optical disc 61 is obtained based on the FG signal of the optical disc 61 and such a focus drive signal is generated that maximizes the reflection signal LVL from the optical disc 61. In this case, focus drive signals which are generated for respective angles which are obtained by dividing the one rotation of the optical disc 61 are stored in the RAM 91 in association with the FG signal. The drive coil 72 is driven by the focus drive signals read out from the RAM 91 according to the FG signal.

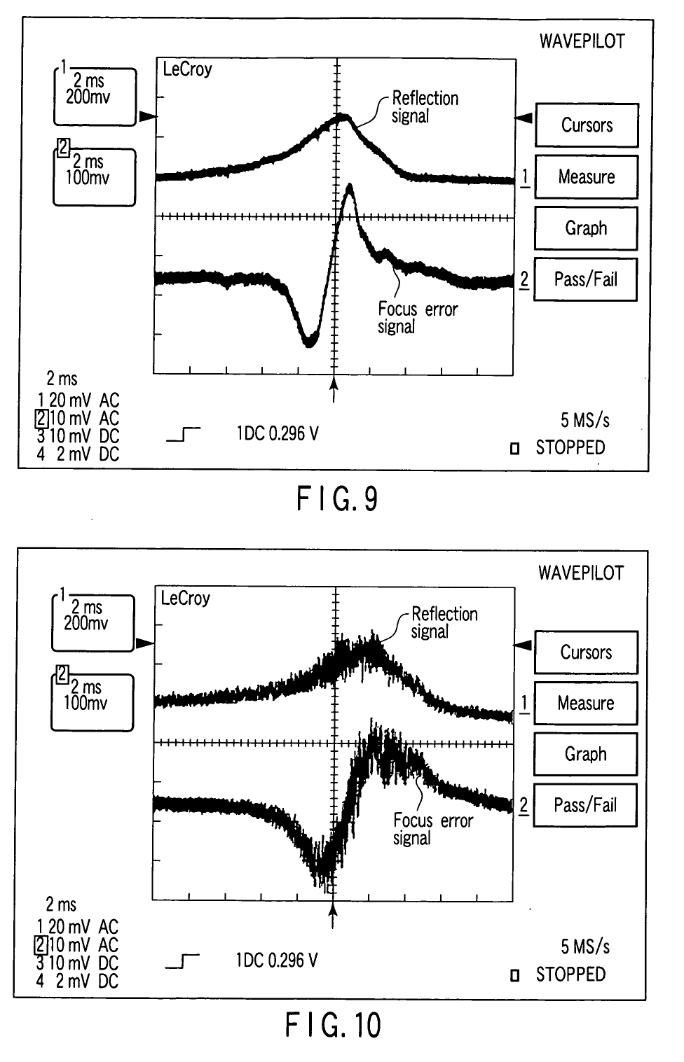

FIG. 9 is a schematic diagram that shows measurement results of the focus error signal FE and reflection signal LVL when an experiment is conducted with the recording surface (mirror surface) of the optical disc 61.

FIG. 10 is a schematic diagram that shows measurement results of the focus error signal FE and reflection signal LVL when the same experiment is conducted with the label surface of the optical disc 61 under the same conditions as FIG. 9. As seen from FIG. 10, with a poor S/N, the accuracy is degraded and noises are attributed to roughness of the optical disc surface.

In the open loop control, learning of focus drive signal of one rotation of the optical disc 61 generates more error as the radial position of the optical disc 61 varies. Therefore, when the optical disc position to be recorded is varied to a certain degree, recording is temporarily stopped and the above-mentioned learning is carried out, and thereafter, new focus drive signal is generated and recording is continued. Meanwhile, the tracking control is performed based on position information detected by a pickup position detector (not shown) equipped to the pickup head unit 65.

The optical disc 61 has concentric tracks. The density of an image (pictograph, characters, etc.) to be printed on the label surface of the optical disc 61 is needed to be changed based on the radial position. This density change is carried out by an application program loaded on the host apparatus 94. Therefore, the CPU 90 receives data for one rotation of each track from the host apparatus 94.

The position of each track is controlled by comparing an output of a pickup position detector (not shown) with a reference signal. The comparison result is converted into a characteristic signal corresponding to a position control in place of the tracking error signal TE, and supplied to the tracking control circuit 88 to drive the tracking coil 72. Displacement of the tracking coil 72 is not reflected to the pickup position detection. That is, it does not configure a feedback loop.

The characteristic signal is supplied to the thread motor control circuit 68 to drive the thread motor 66. Therefore, the position of the pickup head unit 65 is controlled by a feedback loop to coincide the pickup position detector output with the reference signal.

During the movement of the pickup head unit 65, a steady-state error is generated by the effect of friction or the like. This error signal is transmitted to the tracking coil 72, the laser spot position in the tracking direction is corrected, and the steady-state error is compensated for.

A predetermined rotating position on the optical disc 61 is established and one signal is generated per rotation from the FG signal. Alternatively, marking is made on the optical disc 61 and read by the pickup head unit 65, and the read timing is stored in the RAM 91 in accordance with the FG signal. The read operation from the RAM 91 is read in accordance with the FG signal and used. The CPU 90 prints information from a predetermined track on the label surface of the optical disc 61 in accordance with the reference position, and when printing of one track is completed, the CPU 90 moves the pickup head unit 65 to the next track and carries out printing operation. By repeating the above operation, an image or text is printed on the label surface of the optical disc 61.

The Focus error signal FE is not detected during the printing operation. When the information is printed on the label surface of the optical disc 61, the laser-irradiated portion must be blackened (with no reflected light) in order to enhance contrast, and no reflected light from the optical disc 61 can be obtained.

Therefore, when the information is printed on the whole label surface of the optical disc 61, an open servo control (also called the feed-forward method) by the CPU 90 is performed which measures deviation of the optical disc 61 in the focus direction before recording, stores the measurement result in the RAM 91, and drives the drive coil 72 in accordance with the stored measurement result stored in the RAM 91 when the information is printed on the label surface of the optical disc 61.

Two learning methods are available for the focus drive signal.

For the first method, a focus servo control is performed, a focus drive signal during this control is stored to the RAM 91 in accordance with the FG signal timing, and the focus actuator drive coil 71 is driven by the focus drive signal read out from the RAM 91.

If the center of the focus error signal center does not coincide with the maximum of the reflection signal LVL as shown in FIG. 9, the surface roughness of the optical disc label surface appears on signals as shown in FIG. 10. For the second method, deviation of the optical disc 61 is sampled at timings corresponding to sections which are obtained by dividing one rotation, and a focus drive signal is generated by the sampled information.

In order to carry out sampling, focus search is necessary to cause the maximum of the reflection signal LVL to coincide with the center of the focus error signal. Whether or not the reflection signal LVL is maximum is discriminated by displacing the reflection signal position. This search speed must be decreased in order to average the roughness of the reflection signal LVL as shown in FIG. 10.

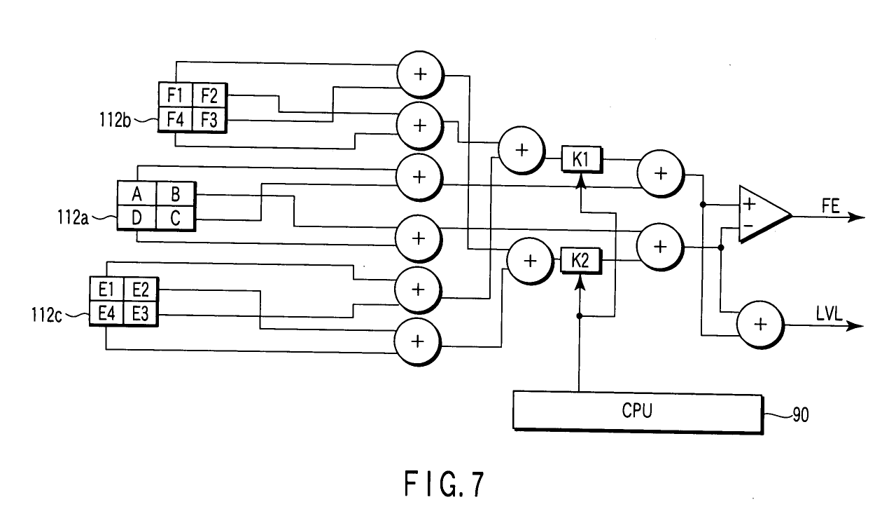

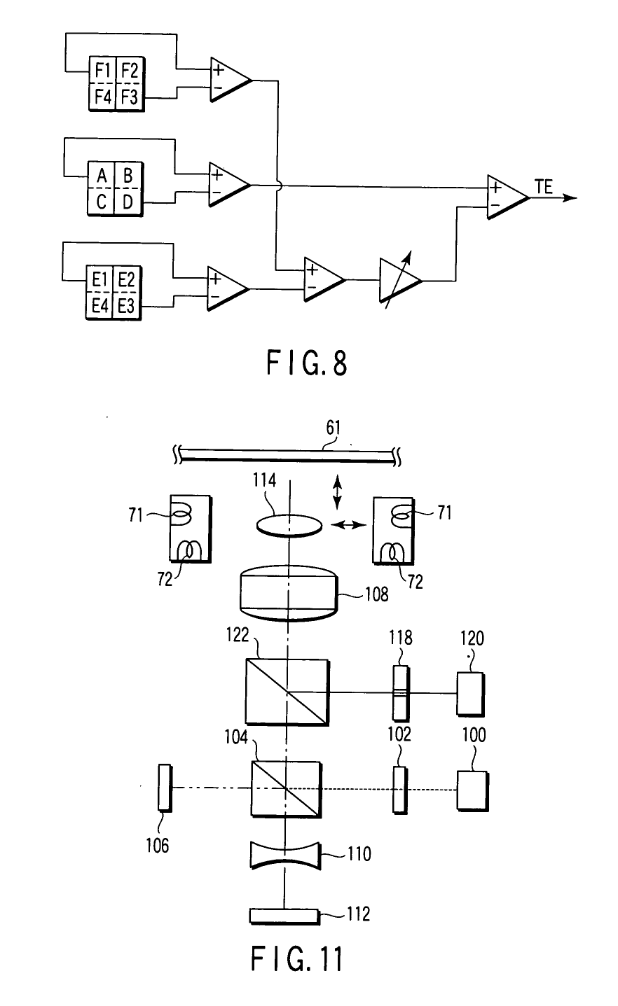

FIG. 7 is a block diagram that indicates processing of the reflection signal LVL and the focus error signal FE. FIG. 8 is a block diagram that indicates processing of the tracking error signal TE.

The light radiated from the laser diode 100 becomes 3 beams (one main beam 162 and two sub-beams 164) as shown in FIG. 6 and are reflected at the optical disc 61. A reflected beam of the main beam 162 is applied to three photo detectors 112a, 112b, and 112c each having four photo detecting cells A-D, E1-E4, and F1-F4. The main beam 162 is led to the photo detectors 112a and the two sub-beams 164 are led to the photo detectors 112b and 112c which are arranged adjacent to the photo detector 112a.

The optical disc apparatus according to the embodiment of the present invention is configured to catch the optical spots which are reflected lights from the optical disc 61.

The focus error signal FE shown in FIG. 7 is obtained by the following calculation:
FE=(A+C)−(B+D)+(F1+F3)−(F2+F4)+(E1+E3)−(E2+E4)

“A” to “D” indicate the output signals from the four cells of the photo detector 112a. “E1” to “E4” indicate the output signals from the four cells of the photo detector 112c. “F1” to “F4” indicate the output signals from the four cells of the photo detector 112b. The reflection signal LVL of FIG. 7 is obtained by the following calculation:
LVL=(A+B+C+D)+(F1+F2+F3+F4)+(E1+E2+E3+E4)

As described above, the focusing control is based on not only the main beam 162 but also the sub-beams 164 which are for the tracking control so that the focusing control is performed by using an enlarged beam spot. Therefore, the surface roughness of the label surface of the optical disc 61 does not affect the focus control and satisfactory focusing control is enabled. The tracking error signal TE shown in FIG. 8 is obtained by the following calculation:
TE=((A+C)−(B+D))−((F1+F4)−(F2+F3))−((E1+E4)−(E2+E3))

As compared to the main beam 162 that is used for information recording or printing, sub-beams 164 which are not used for recording or printing have the optical power reduced to about 1/10. Because the reduced optical power varies depending on a pickup head unit 65, the signal level is optimized by amplifiers K1 and K2 which are shown in FIG. 7.

This optimization method is to monitor the ripple of the focus error signal FE or the reflection signal LVL and to adjust the signal levels to have the minimum ripple by the CPU 90.

The addition ratio of the two sub-beam signals is changed by changing the gains of the amplifiers K1 and K2 by the CPU 90. The addition ratio is determined to minimize the noises of the focus error signal FE and the reflection signal LVL but the ratio may be set to a predetermined value. In addition, the ratio may be changed every time the optical disc 61 is changed. In such event, the gains of the amplifiers K1 and K2 are controlled to optimum values with the noise level after the focus error signal FE and the reflection signal LVL are allowed to pass a high pass filter taken into account.

As described above, since the focusing control is based on the main beam during the information recording to the information recording layer and the focusing control is based on the sum of the main beam 162 and the two sub-beams during the information printing to the label surface, it is possible to increase the area of beam which monitors the focus condition in the case of information printing than that in the case of information recording. Noise of the detection signal used for focus servo in the case of information printing is reduced and focus servo can be stabilized. Therefore, the optical disc apparatus for information recording can be used in common at the time of the label printing.

FIG. 11 is a schematic diagram that indicates the configuration of the optical disc apparatus according to the second embodiment of the present invention. The same portions as those of the first embodiment will be indicated in the same reference numerals and their detailed description will be omitted. The difference between the second embodiment and the first embodiment is that a prism 122, an aperture 118, and a laser diode 120 are added to the first embodiment. That is, the optical disc apparatus for recording and the optical disc apparatus for reproduction are configured independently.

According to the second embodiment, at the time of focus learning, the laser diode 100 is turned off and the laser diode 120 is turned on. The light of the laser diode 120 is restricted by the aperture 118, and numerical aperture (NA) is reduced and the reading spot size on the optical disc 61 is increased. The reflected light from the optical disc 61 is converged to the photo detectors 112a, 112b, and 112c and the focus error signal FE and the reflection signal LVL are obtained. Because the spot size is proportional to λ/NA, it is suitable to reduce the NA (λ:wavelength, NA:numerical aperture).

According to the second embodiment, because independent the optical disc apparatus are used for a recording system and a reproduction system, respectively, it is possible to cause the maximum of the reflection signal LVL to coincide with the center of the focus error signal FE. Further, the reading spot size can be increased.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. An optical disc apparatus using an optical disc having an information recording layer and a label surface, the apparatus comprising:
an pickup head which emits a laser light onto the optical disc;
a printing section which prints information on the label surface based on the laser light emitted from the pickup head; and
a focus control section which adjusts a focus of the laser light emitted from the pickup head to the label surface, wherein a size of the laser light used for adjusting the focus is larger than a size of the laser light used for printing the information on the label surface.

2. The optical disc apparatus according to claim 1, wherein the laser light used for printing the information comprises a main beam and the laser light used for adjusting the focus comprises the main beam and two auxiliary beams.

3. The optical disc apparatus according to claim 2, wherein the two auxiliary beams comprises two sub beams used for tracking control.

4. An optical disc apparatus using an optical disc having an information recording layer and a label surface, the apparatus comprising:
an pickup head which emits a laser light onto the optical disc, the laser light including a main beam and two sub beams;
a tracking control section which shifts the pickup head to perform tracking based on the main beam and the two sub beams reflected from the optical disc;
a focus control section which adjusts a focus of the light beam emitted from the pickup head based on the main beam and the two sub beams reflected from the optical disc; and
a printing section which prints information on the label surface based on the main beam emitted from the pickup head.

5. An optical disc apparatus using an optical disc having an information recording layer and a label surface, the apparatus comprising:
an pickup head which emits a laser light onto the optical disc, the laser light including a main beam and two sub beams; and
a focusing control section which adjusts a focus of the light beam emitted from the pickup head based on the main beam during the information recording with regard to the information recording layer and the main beam and the two sub beams during the information printing with regard to the label surface.
